(19) United States
(12) Patent Application Publication
(10) Pub. No.: US 2024/0357530 A1
(43) Pub. Date: Oct. 24, 2024

(54) COMMUNICATION METHOD AND COMMUNICATIONS APPARATUS

(71) Applicant: GUANGDONG OPPO MOBILE TELECOMMUNICATIONS CORP., LTD., Dongguan (CN)

(72) Inventors: Bin LIANG, Dongguan (CN); Zhe FU, Dongguan (CN)

(21) Appl. No.: 18/761,210

(22) Filed: Jul. 1, 2024

Related U.S. Application Data
(63) Continuation of application No. PCT/CN2022/071022, filed on Jan. 10, 2022.

(51) Int. Cl. H04W 56/00; H04L 5/00

(52) U.S. Cl. CPC H04W 56/0045; H04L 5/0051; H04W 56/009

(57) ABSTRACT

Disclosed are a communication method and a communications apparatus. The method includes: receiving, by a terminal device, a configuration message transmitted by a network device, where the configuration message is used to determine a delay compensation manner of the terminal device; and determining, by the terminal device, a target delay compensation manner based on the configuration message.

### CROSS-REFERENCE TO RELATED APPLICATIONS

This application is a continuation of International Application No. PCT/CN2022/071022, filed on Jan. 10, 2022, the disclosure of which is hereby incorporated by reference in its entirety.

### TECHNICAL FIELD

This application relates to the field of communications technologies, and more specifically, to a communication method and a communications apparatus.

### RELATED ART

With the development of communications technologies, a variety of delay compensation manners (for example, a timing advance-based (TA-based) delay compensation manner and a round trip time-based (RTT-based) delay compensation manner) have been introduced to some communications systems, to reduce transmission delays of the communications systems. However, how to perform delay compensation based on these delay compensation manners is unclear at present.

### SUMMARY

This application provides a communication method and a communications apparatus.

According to a first aspect, a communication method is provided, including: receiving, by a terminal device, a configuration message transmitted by a network device, where the configuration message is used to determine a delay compensation manner of the terminal device; and determining, by the terminal device, a target delay compensation manner based on the configuration message.

According to a second aspect, a communication method is provided, including: transmitting, by a terminal device, capability information to a network device, where the capability information is used to indicate whether the terminal device supports measurement and calculation of RTT information.

According to a third aspect, a communication method is provided, including: transmitting, by a network device, a configuration message to a terminal device, where the configuration message is used to determine a delay compensation manner of the terminal device.

According to a fourth aspect, a communication method is provided, including: receiving, by a network device, capability information transmitted by a terminal device, where the capability information is used to indicate whether the terminal device supports measurement and calculation of RTT information.

According to a fifth aspect, a communications apparatus is provided, including: a receiving unit, configured to receive a configuration message transmitted by a network device, where the configuration message is used to determine a delay compensation manner of the apparatus; and a determining unit, configured to determine a target delay compensation manner based on the configuration message.

According to a sixth aspect, a communications apparatus is provided, including: a transmitting unit, configured to transmit capability information to a network device, where the capability information is used to indicate whether the apparatus supports measurement and calculation of RTT information.

According to a seventh aspect, a communications apparatus is provided, including: a transmitting unit, configured to transmit a configuration message to a terminal device, where the configuration message is used to determine a delay compensation manner of the terminal device.

According to an eighth aspect, a communications apparatus is provided, including: a receiving unit, configured to receive capability information transmitted by a terminal device, where the capability information is used to indicate whether the terminal device supports measurement and calculation of RTT information.

According to a ninth aspect, a communications apparatus is provided, including a memory and a processor, where the memory is configured to store a program, and the processor is configured to invoke the program in the memory to perform the method according to any one of the first aspect, the second aspect, the third aspect, or the fourth aspect.

According to a tenth aspect, a communications apparatus is provided, including: a processor, configured to invoke a program from a memory to perform the method according to any one of the first aspect, the second aspect, the third aspect, or the fourth aspect.

According to an eleventh aspect, a chip is provided, including: a processor, configured to invoke a program from a memory to cause a device installed with the chip to perform the method according to any one of the first aspect, the second aspect, the third aspect, or the fourth aspect.

According to a twelfth aspect, a computer-readable storage medium is provided, storing a program, where the program causes a computer to perform the method according to any one of the first aspect, the second aspect, the third aspect, or the fourth aspect.

According to a thirteenth aspect, a computer program product is provided, including a program, where the program causes a computer to perform the method according to any one of the first aspect, the second aspect, the third aspect, or the fourth aspect.

According to a fourteenth aspect, a computer program is provided, where the computer program causes a computer to perform the method according to any one of the first aspect, the second aspect, the third aspect, or the fourth aspect.

In embodiments of this application, the configuration message is used to determine the delay compensation manner of the terminal device; and the terminal device determines the target delay compensation manner based on the configuration message.

### BRIEF DESCRIPTION OF DRAWINGS

FIG. 1 is an example diagram of a wireless communications system to which an embodiment of this application is applied.

FIG. 2 is a schematic flowchart of a communication method according to an embodiment of this application.

FIG. 3 is a schematic flowchart of a communication method according to another embodiment of this application.

FIG. 4 is a schematic diagram of RTT measurement according to an embodiment of this application.

FIG. 5 is a schematic structural diagram of a communications apparatus according to an embodiment of this application.

FIG. 6 is a schematic structural diagram of a communications apparatus according to another embodiment of this application.

FIG. 7 is a schematic structural diagram of a communications apparatus according to still another embodiment of this application.

FIG. 8 is a schematic structural diagram of a communications apparatus according to yet another embodiment of this application.

FIG. 9 is a schematic structural diagram of an apparatus according to an embodiment of this application.

### DESCRIPTION OF EMBODIMENTS

The following describes technical solutions in this application with reference to accompanying drawings.

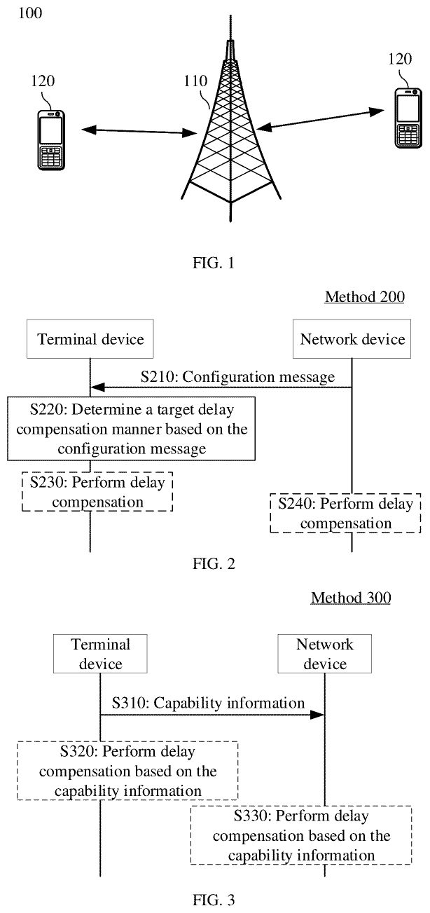

FIG. 1 shows a wireless communications system 100 to which an embodiment of this application is applied. The wireless communications system 100 may include a network device 110 and user equipments (UEs) 120. The network device 110 can communicate with the UEs 120. The network device 110 can provide communication coverage for a specific geographic area, and can communicate with UEs 120 within the coverage area. The UEs 120 can access a network (for example, a wireless network) through the network device 110.

FIG. 1 exemplarily shows one network device and two UEs. Optionally, the wireless communications system 100 may include a plurality of network devices, and another quantity of terminal devices may be included within a coverage range of each network device. This is not limited in embodiments of this application. Optionally, the wireless communications system 100 may further include other network entities, such as a network controller and a mobility management entity. This is not limited in embodiments of this application.

It should be understood that technical solutions of embodiments of this application may be applied to various communications systems, such as a fifth generation (5G) system or a new radio (NR), a long term evolution (LTE) system, an LTE frequency division duplex (FDD) system, and an LTE time division duplex (TDD) system. The technical solutions provided in this application may further be applied to a future communications system, such as a 6th generation mobile communications system or a satellite communications system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, a user apparatus, or the like. The UE in embodiments of this application may be a device providing a user with voice and/or data connectivity, and may be configured to connect people, objects, and machines. For example, the UE is a handheld device, a vehicle-mounted device, or the like having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. Optionally, the UE may be configured to act as a base station. For example, the UE may act as a scheduling entity, which provides a sidelink signal between UEs in V2X, D2D, or the like. For example, a cellular phone and a vehicle communicate with each other by using a sidelink signal. However, a cellular phone and a smart home device can communicate with each other without relaying of a communication signal by a base station.

The network device in embodiments of this application may be a device configured to communicate with the UE. The network device may also be referred to as an access network device or a wireless access network device. For example, the network device may be a base station. The network device in embodiments of this application may be a radio access network (RAN) node (or device) that connects the UE to a wireless network. The base station may broadly cover various names in the following, or may be interchangeable with the following names, for example: a NodeB, an evolved NodeB (eNB), a next generation NodeB (gNB), a relay station, a transmitting and receiving point (TRP), a transmitting point (TP), a master eNB MeNB, a secondary eNB SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node. The base station may be a macro base station, a micro base station, a relay node, a donor node, or the like, or a combination thereof.

In some embodiments, the network device may be fixed or mobile. For example, a helicopter or a drone may be configured to act as a mobile network device, and one or more cells may move according to the position of the mobile network device. In other examples, a helicopter or a drone may be configured to serve as a device in communication with another network device. In some embodiments, the network device may be a CU or a DU; or the network device may include a CU and a DU; or the network device may further include an AAU.

It should be understood that the network device may be deployed on land, including indoor, outdoor, handheld, or vehicle-mounted deployment; may be deployed on water; or may be deployed on an airplane, a balloon, or a satellite in the air. The network device and a scenario in which the network device is located in embodiments of this application are not limited in embodiments of this application.

It should also be understood that all or some of functions of the network device and the UE in this application may also be implemented by software functions running on hardware, or by virtualization functions instantiated on a platform (for example, a cloud platform).

In a transmission process of wireless communication, both transmission and parsing of a wireless signal need to take time, resulting in a delay between transmitting the wireless signal by a transmitter and receiving the wireless signal by a receiver. For example, when a terminal device has a data packet that needs to be transmitted to a network device, the terminal device needs to initiate a scheduling request (SR) for a radio resource to the network device, thereby notifying the network device that the terminal device has data to be transmitted. After receiving the scheduling request, the network device needs to spend time parsing the scheduling request transmitted by the terminal device, then schedule a resource for the terminal device, and transmit a scheduling grant to the terminal device, thereby instructing the terminal device to transmit, at a specific time and a specific frequency, the data that the terminal device wants to transmit. Transmission of the scheduling grant needs to take time. After receiving the scheduling grant, the terminal device needs to spend time decoding the scheduling grant, and transmit the data to a network on the resource indicated by the scheduling grant. After receiving the data transmitted by the terminal device, the network device needs to spend time decoding the data, and transmission of the data needs to take time. Subsequently, the transmission of the data is completed. It can be learned that the data process includes a plurality of times of data transmission and parsing, both of which need to take time. As a result, a transmission delay is generated.

With the development of communications technologies, a concept of time sensitive networking (TSN) or time sensitive communication (TSC) is proposed. Accordingly, higher requirements are imposed on a transmission delay and clock synchronization accuracy of a communications system. For example, in some communications systems, transmission of a TSN service needs to meet time synchronization accuracy being less than 900 nanoseconds (ns).

To implement time sensitive networking or time sensitive communication, a solution, namely, compensating for the transmission delay of the communications system, is proposed in the art to reduce the transmission delay of the communications system. Currently, a variety of delay compensation manners (for example, a TA-based delay compensation manner and a RTT-based delay compensation manner)) are proposed to compensate for a transmission delay of a communications system. However, how to perform delay compensation based on these delay compensation manners (for example, in what case, which manner is used for delay compensation) is unclear at present.

In an example in which the TA-based delay compensation manner is used to compensate for a transmission delay of a communications system, a terminal device may determine a compensation value based on TA information, and use the compensation value to compensate for the transmission delay of the communications system. For example, the terminal device may determine, as the compensation value, a delay compensation value indicated by the TA information.

In an example in which the RTT-based delay compensation manner is used to compensate for a transmission delay of a communications system, a terminal device may determine a compensation value based on RTT information. For example, the terminal device may determine, as the compensation value, a time difference indicated by the RTT information.

To resolve one or more of the foregoing technical problems, this application provides a communication method and a communications apparatus. In embodiments of this application, a terminal device determines a target delay compensation manner based on a reception status of configuration information. This helps the terminal device compensate for a transmission delay.

The following exemplarily describes embodiments of this application in detail with reference to FIG. 2 to FIG. 4.

FIG. 2 is a schematic flowchart of a communication method according to an embodiment of this application. It should be understood that FIG. 2 shows steps or operations of the communication method. However, these steps or operations are merely examples; and other operations or variations of the operations in FIG. 2 may be further performed in embodiments of this application. Alternatively, not all these steps need to be performed; or these steps may be performed in another sequence. The method 200 shown in FIG. 2 may include steps S210 and S220. Details are as follows.

S210: A network device transmits a configuration message to a terminal device.

The configuration message may be used to determine a delay compensation manner of the terminal device. For example, the configuration message may be a radio resource control (RRC) message, a network configuration message included in an RRC message, or another configuration message transmitted by the network device.

Optionally, the configuration message may instruct the terminal device to perform delay compensation or instruct the network device not to perform delay compensation. Accordingly, the terminal device can learn that delay compensation is implemented by the terminal device (itself).

Alternatively, the configuration message is used to instruct the terminal device not to perform delay compensation or instruct the network device to perform delay compensation. Accordingly, the terminal device can learn that delay compensation is implemented by the network device.

Optionally, the configuration message may be used to carry configuration information of a reference signal. The reference signal may include one or more of the following signals: a sounding reference signal (SRS), a channel status indication reference signal (CSIRS), a phase tracking reference signal (PTRS), and a tracking reference signal (TRS).

For example, the configuration message received by the terminal device may include related configuration information such as SRS-Config (used to configure an SRS), or phaseTrackingRS (used to activate a PTRS), or PTRS-DownlinkConfig (used to configure a PTRS).

An understanding of the configuration information of the reference signal is as follows: The configuration information is used to configure the reference signal of the terminal device. In other words, a specific of the reference signal of the terminal device can be determined based on the configuration information. For example, the configuration information may be configuration information of an SRS transmitted by the network device. Accordingly, the terminal device may configure the SRS by using the configuration information.

In embodiments of this application, delay compensation may be implemented by the terminal device, or delay compensation may be implemented by the network device. In subsequent embodiments, in a case that delay compensation is performed by the terminal device, the terminal device may determine, based on whether the configuration message includes (or bears or carries) the configuration information of the reference signal, a manner (namely, a target delay compensation manner) of performing delay compensation.

S220: The terminal device determines a target delay compensation manner based on the configuration message.

The target delay compensation manner herein may be: performing delay compensation by the terminal device or performing delay compensation by the network device. The target delay compensation manner may alternatively be: a specific manner used by the terminal device to perform delay compensation in a case that delay compensation is performed by the terminal device. For example, the terminal device may use a TA-based delay compensation manner or an RTT-based delay compensation manner to perform delay compensation.

A status of implementing delay compensation by the terminal device is described in detail below first.

In some possible implementations, the configuration message may instruct the terminal device to perform delay compensation or instruct the network device not to perform delay compensation. In this case, the terminal device can determine that delay compensation is performed by the terminal device (itself).

In a case that delay compensation is performed by the terminal device, the terminal device may determine, in a plurality of manners, the target delay compensation manner in which delay compensation is performed. Details are as follows.

Manner 1: The terminal device may determine the target delay compensation manner based on whether the configuration message includes the configuration information of the reference signal.

In other words, it may be considered that the configuration information of the reference signal may be used to indicate the target delay compensation manner. For example, determining a specific delay compensation manner based on whether the configuration message includes the configuration information may also be referred to as indicating the delay compensation manner by the configuration information.

For example, in a case that the configuration message includes the configuration information of the reference signal, it may be considered that the configuration information indicates an RTT-based delay compensation manner, and that the terminal device may determine the RTT-based delay compensation manner as the target delay compensation manner.

For another example, in a case that the configuration message does not include the configuration information of the reference signal, it may be considered that the configuration information indicates a TA-based delay compensation manner, and that the terminal device may determine the TA-based delay compensation manner as the target delay compensation manner.

In some possible implementations, the terminal device may determine the target delay compensation manner from a TA-based delay compensation manner and a RTT-based delay compensation manner based on whether the configuration message includes the configuration information.

For example, in a case that the configuration message does not include the configuration information, the terminal device may determine the TA-based delay compensation manner as the target delay compensation manner. In this way, in a case that the configuration information has not been received, the TA-based delay compensation manner can be used to compensate for a transmission delay, so that a transmission delay of a communications system can be reduced.

For another example, in a case that the configuration message includes the configuration information, the terminal device may determine the RTT-based delay compensation manner as the target delay compensation manner. Because compensation precision of the RTT-based delay compensation manner is usually higher than that of the TA-based delay compensation manner, in a case that the configuration information has been received, the terminal device preferentially selects the RTT-based delay compensation manner to compensate for a transmission delay, which can further reduce the transmission delay of the communications system.

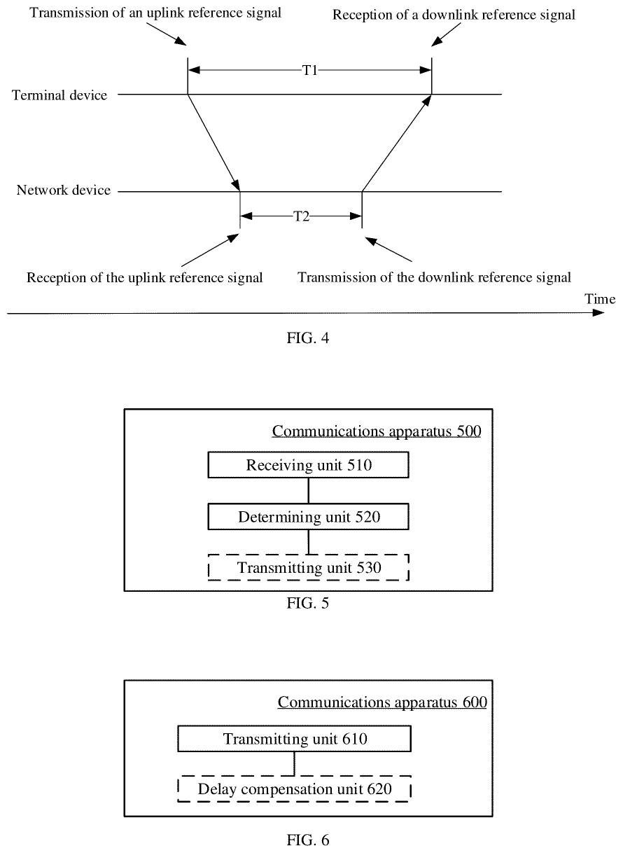

The RTT-based delay compensation manner is explained herein. For example, as shown in FIG. 4, a network device side (for example, a gNB) may measure a time period T2 (namely, first RTT information in the following), and a terminal device side may measure a time period T1 (namely, second RTT information in the following). In a case that the terminal device performs delay compensation, the network device side may notify the terminal device of T2. In this way, the terminal device may determine that a delay of propagation between the terminal device and the network device is (T1−T2)/2. Alternatively, in a case that the network device performs delay compensation, the terminal device may notify the network device side of T1. In this way, the network device may determine that a delay of propagation between the terminal device and the network device is (T1−T2)/2. Both T1 and T2 are positive integers.

In some possible implementations, the terminal device may alternatively determine the target delay compensation manner based on a reception status of the first RTT information, where the first RTT information may be a time difference between a moment when the network device receives an uplink reference signal transmitted by the terminal device and a moment when the network device transmits a downlink reference signal to the terminal device. For example, as shown in FIG. 4, the first RTT information may be the time period T2, that is, the first RTT information may be the difference between the moment when the network device receives the uplink reference signal and the moment when the network device transmits the downlink reference signal. Optionally, the network device may transmit the first RTT information to the terminal device. Certainly, for a method of determining the first RTT information by the network device, reference may be made to the conventional technology. This is not limited in embodiments of this application.

For example, in a case that the terminal device has received the configuration information, the terminal device may further determine the target delay compensation manner from the TA-based delay compensation manner and the RTT-based delay compensation manner based on the reception status of the first RTT information.

As an example in which the terminal device selects the target delay compensation manner from the TA-based delay compensation manner and the RTT-based delay compensation manner based on the reception status of the first RTT information, the terminal device may determine the TA-based delay compensation manner as the target delay compensation manner in a case that the terminal device has not received the first RTT information. In this way, in a case that the first RTT information has not been received, the TA-based delay compensation manner can be used to compensate for a transmission delay, so that a transmission delay of a communications system can be reduced.

As another example in which the terminal device selects the target delay compensation manner from the TA-based delay compensation manner and the RTT-based delay compensation manner based on the reception status of the first RTT information, the terminal device may determine the RTT-based delay compensation manner as the target delay compensation manner in a case that the terminal device has received the first RTT information. In a case that the first RTT information has been received, the terminal device preferentially selects the RTT-based delay compensation manner to compensate for a transmission delay, so that the transmission delay of the communications system can be further reduced.

In some possible implementations, the terminal device may alternatively determine the target delay compensation manner based on a reception status of TA information, where the TA information may be transmitted by the network device by using a medium access control layer control element (MAC CE). Optionally, the TA information may indicate a delay compensation value. For example, the TA information may be transmitted to the terminal device by using a timing advance command (TAC), where the TAC may be carried in the MAC CE. Accordingly, the terminal device may perform delay compensation based on the delay compensation value indicated by the TA information.

Further, the reception status of the TA information may be whether the terminal device has received the TA information.

For example, in a case that the terminal device has received the configuration information and has received the RTT information, the terminal device may further determine the target delay compensation manner from the TA-based delay compensation manner and the RTT-based delay compensation manner based on the reception status of the TA information.

For another example, in a case that the terminal device has received the configuration information, the terminal device may further determine the target delay compensation manner from the TA-based delay compensation manner and the RTT-based delay compensation manner based on the reception status of the TA information.

For still another example, in a case that the terminal device has received the configuration information but has not received the RTT information, the terminal device may further determine the target delay compensation manner from the TA-based delay compensation manner and the RTT-based delay compensation manner based on the reception status of the TA information.

As a first example in which the terminal device determines the target delay compensation manner from the TA-based delay compensation manner and the RTT-based delay compensation manner based on the reception status of the TA information, the terminal device may determine the RTT-based delay compensation manner as the target delay compensation manner in a case that the terminal device has not received the TA information.

As a second example in which the terminal device determines the target delay compensation manner from the TA-based delay compensation manner and the RTT-based delay compensation manner based on the reception status of the TA information, the terminal device may determine the TA-based delay compensation manner as the target delay compensation manner in a case that the terminal device has received the TA information.

As a third example in which the terminal device determines the target delay compensation manner from the TA-based delay compensation manner and the RTT-based delay compensation manner based on the reception status of the TA information, the terminal device may determine the RTT-based delay compensation manner as the target delay compensation manner in a case that the terminal device has received the TA information.

As a fourth example in which the terminal device selects the target delay compensation manner from the TA-based delay compensation manner and the RTT-based delay compensation manner based on the reception status of the TA information, in a case that the terminal device has received the TA information, the terminal device may determine the target delay compensation manner from the TA-based delay compensation manner and the RTT-based delay compensation manner based on a sequence between a receiving time of the first RTT information and a receiving time of the TA information.

In an implementation in which the terminal device determines the target delay compensation manner from the TA-based delay compensation manner and the RTT-based delay compensation manner based on the sequence between the receiving time of the first RTT information and the receiving time of the TA information, the terminal device may perform delay compensation based on information, having the later receiving time, of the first RTT information and the TA information. Because the information having the later receiving time has higher effectiveness and is more timely, accuracy of delay compensation performed based on the information is higher.

For example, in a case that the receiving time of the TA information is before the receiving time of the RTT information, the terminal device may determine the RTT-based delay compensation manner as the target delay compensation manner. For example, if the terminal device receives the TA information first and then receives the first RTT information, the terminal device may select the RTT-based delay compensation manner as the target delay compensation manner. In other words, if the terminal device receives the RTT information relatively late, the terminal device may perform delay compensation in an RTT manner.

For another example, in a case that the receiving time of the TA information is after the receiving time of the first RTT information, the terminal device may select the TA-based delay compensation manner as the target delay compensation manner. For example, if the terminal device receives the first RTT information first and then receives the TA information, the terminal device may select the TA-based delay compensation manner as the target delay compensation manner. In other words, if the terminal device receives the TA information relatively late, the terminal device may perform delay compensation in a TA manner.

Certainly, the terminal device may alternatively perform delay compensation based on information, having the earlier receiving time, of the first RTT information and the TA information. This is not limited in embodiments of this application.

Manner 2: The terminal device may determine the target delay compensation manner based on the configuration message.

For example, the configuration message may instruct the terminal device to perform delay compensation in the TA-based delay compensation manner or the RTT-based delay compensation manner.

In a case that the configuration message instructs the terminal device to perform delay compensation in the TA-based delay compensation manner, the terminal device may perform delay compensation in the TA-based delay compensation manner.

In a case that the configuration message instructs the terminal device to perform delay compensation in the RTT-based delay compensation manner, the terminal device may perform delay compensation in the RTT-based delay compensation manner.

Further, the method 200 may further include a step S230. Details are as follows.

S230: The terminal device performs delay compensation.

For example, in a case that the TA-based delay compensation manner is determined as the target delay compensation manner, the terminal device may determine a compensation value for a delay of transmission between the terminal device and the network device in the TA-based delay compensation manner.

For another example, in a case that the RTT-based delay compensation manner is determined as the target delay compensation manner, the terminal device may determine a compensation value for a delay of transmission between the terminal device and the network device in the RTT-based delay compensation manner.

For a specific method for determining the compensation value mentioned in the foregoing embodiments, reference may be made to the conventional technology. Details are not described herein again.

After determining the compensation value, the terminal device may compensate for the transmission delay by using the compensation value. For example, the terminal device may adjust a reference time (which may also be referred to as a reference time point or a reference moment) in a radio frequency processing unit (of the terminal device) based on the compensation value. Specifically, the terminal device may advance or postpone the reference time in the radio frequency processing unit. For a specific method for compensating for the transmission delay, reference may be made to the conventional technology. Details are not described herein again.

The foregoing embodiments describe a method for implementing delay compensation by a terminal device. A status of implementing delay compensation by a network device is described below in detail.

In some possible implementations, the configuration message may instruct the terminal device not to perform delay compensation or instruct the network device to perform delay compensation. In this case, the terminal device can determine that delay compensation is performed by the network device (itself).

Further, the method 200 may further include a step S240. Details are as follows.

S240: The network device performs delay compensation.

Optionally, the terminal device may transmit capability information to the network device, where the capability information may be used to indicate whether the terminal device supports measurement and calculation of RTT information.

In a case that the capability information indicates that the terminal device supports measurement and calculation of the RTT information, the network device may perform delay compensation in the RTT-based delay compensation manner.

For example, in a case that the capability information indicates that the terminal device supports measurement and calculation of the RTT information, the terminal device may transmit second RTT information to the network device, where the second RTT information may be a time difference between a moment when the terminal device transmits an uplink reference signal and a moment when the terminal device receives a downlink reference signal transmitted by the network device. For example, as shown in FIG. 4, the second RTT information may be the time period T1, that is, the second RTT information may be a difference between the moment when the terminal device transmits the uplink reference signal and the moment when the terminal device receives the downlink reference signal. Accordingly, the network device may perform delay compensation based on the second RTT information.

Further, before the terminal device transmits the capability information to the network device, the network device may further transmit reporting indication information or reporting configuration information to the terminal device, where the reporting indication information or the reporting configuration information may be used to instruct the network device to perform delay compensation in the RTT-based delay compensation manner.

In response to the reporting indication information or the reporting configuration information, the terminal device may transmit the second RTT information to the network device. In other words, the terminal device may transmit the second RTT information to the network device based on the reporting indication information or the reporting configuration information.

Optionally, the reporting configuration information may further instruct the terminal device to transmit the second RTT information to the network device according to a preset cycle. Accordingly, the terminal device may transmit the second RTT information to the network device according to the preset cycle.

In a case that the capability information indicates that the terminal device does not support measurement and calculation of the RTT information, the network device may perform delay compensation in the TA-based delay compensation manner.

In embodiments of this application, the configuration message is used to determine the delay compensation manner of the terminal device; and the terminal device determines the target delay compensation manner based on the configuration message. This helps the terminal device compensate for a delay of transmission between the terminal device and the network device in the delay compensation manner.

Embodiments of determining a delay compensation manner based on a configuration message are described above. Embodiments of determining a delay compensation manner based on capability information are described below in detail with reference to FIG. 3.

FIG. 3 is a schematic flowchart of a communication method according to an embodiment of this application. The method 300 shown in FIG. 3 may include a step S310. Details are as follows.

S310: A terminal device transmits capability information to a network device.

The capability information may indicate whether the terminal device supports measurement and calculation of RTT information.

In embodiments of this application, delay compensation may be implemented by the terminal device, or delay compensation may be implemented by the network device.

Optionally, whether delay compensation is performed by the terminal device or the network device may be determined according to a plurality of methods.

Method 1: Appoint in advance the terminal device or the network device to perform delay compensation.

For example, the terminal device may be appointed in advance to perform delay compensation, or the network device may be appointed in advance to perform delay compensation.

Method 2: Determine, based on reporting indication information or reporting configuration information, whether delay compensation is performed by the terminal device or the network device.

For example, the reporting indication information or the reporting configuration information may instruct the terminal device or the network device to perform delay compensation.

Method 3: Determine, based on the capability information, that delay compensation is performed by the terminal device or the network device.

For example, in a case that the capability information indicates that the terminal device supports measurement and calculation of the RTT information, it may be determined that delay compensation is performed by the network device; in a case that the capability information indicates that the terminal device does not support measurement and calculation of the RTT information, it may be determined that delay compensation is performed by the terminal device.

Method 4: Determine, based on whether the terminal device transmits second RTT information, delay compensation is performed by the terminal device or the network device. For example, in a case that the terminal device has transmitted the second RTT information to the network device, it may be determined that delay compensation is performed by the network device; in a case that the terminal device has not transmitted the second RTT information to the network device, it may be determined that delay compensation is performed by the terminal device.

A status of implementing delay compensation by the terminal device is described in detail below first.

Optionally, in a case that delay compensation is implemented by the terminal device, the method 300 may further include a step S320. Details are as follows.

S320: The terminal device performs delay compensation based on the capability information.

For example, in a case that the capability information is used to indicate that the terminal device supports measurement and calculation of the RTT information, the terminal device may perform delay compensation in an RTT-based delay compensation manner.

For another example, in a case that the capability information is used to indicate that the terminal device does not support measurement and calculation of the RTT information, the terminal device may perform delay compensation in a TA-based delay compensation manner.

The foregoing embodiments describe a method for implementing delay compensation by a terminal device. A status of implementing delay compensation by a network device is described below in detail.

Optionally, in a case that delay compensation is implemented by the network device, the method may further include a step S330. Details are as follows.

S330: The network device performs delay compensation based on the capability information.

For example, in a case that the capability information is used to indicate that the terminal device supports measurement and calculation of the RTT information, the network device may perform delay compensation in an RTT-based delay compensation manner.

For another example, in a case that the capability information is used to indicate that the terminal device does not support measurement and calculation of the RTT information, the network device may perform delay compensation in a TA-based delay compensation manner.

Optionally, the reporting indication information or the reporting configuration information may also instruct the network device to perform delay compensation in the RTT-based delay compensation manner. In this case, the network device may perform delay compensation in the RTT-based delay compensation manner.

In embodiments of this application, the capability information is used to indicate whether the terminal device supports measurement and calculation of the RTT information, and the terminal device compensates for a transmission delay based on the capability information, so that a delay of transmission between the terminal device and the network device can be reduced.

The foregoing describes method embodiments of this application in detail with reference to FIG. 1 to FIG. 4. The following describes apparatus embodiments of this application in detail with reference to FIG. 5 to FIG. 9. It should be understood that the descriptions of the method embodiments correspond to the descriptions of the apparatus embodiments, and therefore, for parts that are not described in detail, reference may be made to the foregoing method embodiments.

FIG. 5 is a schematic structural diagram of a communications apparatus according to an embodiment of this application. As shown in FIG. 5, the apparatus 500 includes a receiving unit 510 and a determining unit 520. Details are as follows.

The receiving unit 510 is configured to receive a configuration message transmitted by a network device, where the configuration message is used to determine a delay compensation manner of the apparatus.

The determining unit 520 is configured to determine a target delay compensation manner based on the configuration message.

Optionally, the configuration message is used to instruct the apparatus to perform delay compensation or instruct the network device not to perform delay compensation. Accordingly, the determining unit 520 is specifically configured to: determine the target delay compensation manner based on whether the configuration message includes configuration information of a reference signal.

Optionally, the determining unit 520 is specifically configured to: determine the target delay compensation manner from a TA-based delay compensation manner and a RTT-based delay compensation manner based on whether the configuration message includes the configuration information.

Optionally, the determining unit 520 is specifically configured to: in a case that the configuration message does not include the configuration information, determine the TA-based delay compensation manner as the target delay compensation manner.

Optionally, the determining unit 520 is specifically configured to: in a case that the configuration message includes the configuration information, determine the RTT-based delay compensation manner as the target delay compensation manner.

Optionally, the determining unit 520 is specifically configured to: in a case that the configuration message includes the configuration information, determine the target delay compensation manner from the TA-based delay compensation manner and the RTT-based delay compensation manner based on a reception status of first RTT information.

Optionally, the determining unit 520 is specifically configured to: in a case that the apparatus has not received the first RTT information, determine the TA-based delay compensation manner as the target delay compensation manner.

Optionally, the determining unit 520 is specifically configured to: in a case that the apparatus has received the first RTT information, determine the RTT-based delay compensation manner as the target delay compensation manner.

Optionally, the determining unit 520 is specifically configured to: in a case that the apparatus has received the first RTT information, determine the target delay compensation manner from the TA-based delay compensation manner and the RTT-based delay compensation manner based on a reception status of TA information.

Optionally, the determining unit 520 is specifically configured to: in a case that the apparatus has not received the TA information, determine the RTT-based delay compensation manner as the target delay compensation manner.

Optionally, the determining unit 520 is specifically configured to: in a case that the apparatus has received the TA information, determine the target delay compensation manner from the TA-based delay compensation manner and the RTT-based delay compensation manner based on a sequence between a receiving time of the first RTT information and a receiving time of the TA information.

Optionally, the determining unit 520 is specifically configured to: in a case that the receiving time of the TA information is before the receiving time of the first RTT information, determine the RTT-based delay compensation manner as the target delay compensation manner.

Optionally, the determining unit 520 is specifically configured to: in a case that the receiving time of the TA information is after the receiving time of the first RTT information, determine the TA-based delay compensation manner as the target delay compensation manner.

Optionally, the configuration message is used to instruct the apparatus to perform delay compensation based on the TA-based delay compensation manner or the RTT-based delay compensation manner.

Optionally, the reference signal includes one or more of the following signals: a sounding reference signal SRS, a channel status indication reference signal CSIRS, a phase tracking reference signal PTRS, and a tracking reference signal TRS.

Optionally, the configuration message is used to instruct the apparatus not to perform delay compensation or instruct the network device to perform delay compensation.

Optionally, the apparatus 500 further includes a transmitting unit 530, configured to: transmit capability information to the network device, where the capability information is used to indicate whether the apparatus supports measurement and calculation of RTT information.

Optionally, the transmitting unit 530 is further configured to: in a case that the capability information indicates that the apparatus supports measurement and calculation of the RTT information, transmit second RTT information to the network device.

Optionally, the receiving unit 510 is further configured to: receive reporting indication information or reporting configuration information, where the reporting indication information or the reporting configuration information is used to instruct the network device to perform delay compensation in an RTT-based delay compensation manner.

Optionally, the reporting configuration information further instructs the apparatus to transmit second RTT information to the network device according to a preset cycle.

Optionally, the transmitting unit 530 is further configured to: transmit second RTT information to the network device based on the reporting indication information or the reporting configuration information.

FIG. 6 is a schematic structural diagram of a communications apparatus according to an embodiment of this application. As shown in FIG. 6, the apparatus 600 includes a transmitting unit 610. Details are as follows.

The transmitting unit 610 is configured to transmit capability information to a network device, where the capability information is used to indicate whether the apparatus supports measurement and calculation of RTT information.

Optionally, the apparatus 600 further includes a delay compensation unit 620, configured to: in a case that the capability information is used to indicate that the apparatus supports measurement and calculation of the RTT information, perform delay compensation in an RTT-based delay compensation manner.

Optionally, the delay compensation unit 620 is further configured to: in a case that the capability information is used to indicate that the apparatus does not support measurement and calculation of the RTT information, perform delay compensation in a TA-based delay compensation manner.

FIG. 7 is a schematic structural diagram of a communications apparatus according to an embodiment of this application. As shown in FIG. 7, the apparatus 700 includes a transmitting unit 710. Details are as follows.

The transmitting unit 710 is configured to transmit a configuration message to a terminal device, where the configuration message is used to determine a delay compensation manner of the terminal device.

Optionally, the configuration message is used to instruct the terminal device to perform delay compensation or instruct the apparatus not to perform delay compensation.

Optionally, the transmitting unit 710 is further configured to: transmit first RTT information to the terminal device.

Optionally, the transmitting unit 710 is further configured to: transmit TA information to the terminal device.

Optionally, the configuration message is used to instruct the terminal device not to perform delay compensation or instruct the apparatus to perform delay compensation.

Optionally, the apparatus 700 further includes a receiving unit 720, configured to: receive capability information transmitted by the terminal device, where the capability information is used to indicate whether the terminal device supports measurement and calculation of RTT information.

Optionally, the receiving unit 720 is further configured to: in a case that the capability information indicates that the terminal device supports measurement and calculation of the RTT information, receive second RTT information transmitted by the terminal device.

Optionally, the transmitting unit 710 is further configured to: transmit reporting indication information or reporting configuration information to the terminal device, where the reporting indication information or the reporting configuration information is used to instruct the apparatus to perform delay compensation in an RTT-based delay compensation manner.

Optionally, the reporting configuration information further instructs the terminal device to transmit second RTT information to the apparatus according to a preset cycle.

Optionally, the receiving unit 720 is further configured to: receive, based on the reporting indication information or the reporting configuration information, second RTT information transmitted by the terminal device.

Optionally, the apparatus 700 further includes a delay compensation unit 730, configured to: perform delay compensation based on the second RTT information.

FIG. 8 is a schematic structural diagram of a communications apparatus according to an embodiment of this application. As shown in FIG. 8, the apparatus 800 includes a receiving unit 810. Details are as follows.

The receiving unit 810 is configured to receive capability information transmitted by a terminal device, where the capability information is used to indicate whether the terminal device supports measurement and calculation of RTT information.

Optionally, the apparatus 800 further includes a delay compensation unit 820, configured to: in a case that the capability information is used to indicate that the terminal device supports measurement and calculation of the RTT information, perform delay compensation in an RTT-based delay compensation manner.

Optionally, the apparatus 800 further includes a delay compensation unit 820, configured to: in a case that the capability information is used to indicate that the terminal device does not support measurement and calculation of the RTT information, perform delay compensation in a TA-based delay compensation manner.

Optionally, the receiving unit 810 is further configured to: receive second RTT information transmitted by the terminal device.

Optionally, the apparatus 800 further includes a transmitting unit 830, configured to: transmit reporting indication information or reporting configuration information to the terminal device, where the reporting indication information or the reporting configuration information is used to instruct the apparatus to perform delay compensation in an RTT-based delay compensation manner.

Optionally, the reporting configuration information further instructs the terminal device to transmit second RTT information to the network device according to a preset cycle.

Optionally, the receiving unit 810 is further configured to: receive, based on the reporting indication information or the reporting configuration information, second RTT information transmitted by the terminal device.

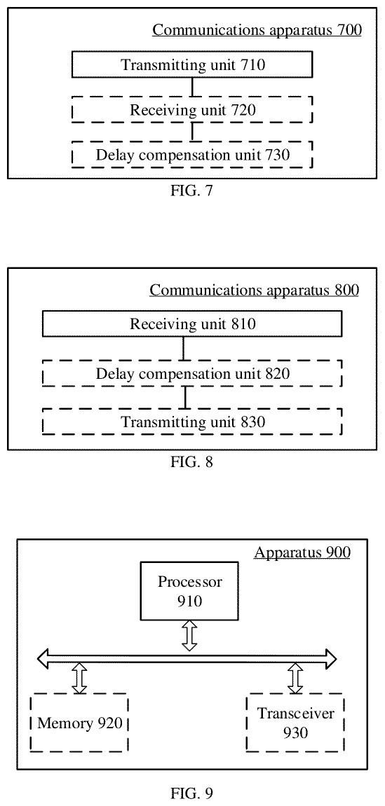

FIG. 9 is a schematic structural diagram of an apparatus according to an embodiment of this application. Dashed lines in FIG. 9 indicate that the unit or module is optional. The apparatus 900 may be configured to implement a method described in the foregoing method embodiments. The apparatus 900 may be a chip or a communications apparatus.

The apparatus 900 may include one or more processors 910. The processor 910 may allow the apparatus 900 to implement a method described in the foregoing method embodiments. The processor 910 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 900 may further include one or more memories 920. The memory 920 stores a program. The program may be executed by the processor 910, to cause the processor 910 to perform a method described in the foregoing method embodiments. The memory 920 may be independent of the processor 910 or may be integrated into the processor 910.

The apparatus 900 may further include a transceiver 930. The processor 910 may communicate with another device or chip through the transceiver 930. For example, the processor 910 may transmit data to and receive data from another device or chip through the transceiver 930.

An embodiment of this application further provides a computer-readable storage medium, configured to store a program. The computer-readable storage medium may be applied to a communications apparatus provided in embodiments of this application, and the program causes a computer to perform a method to be performed by the communications apparatus in various embodiments of this application.

An embodiment of this application further provides a computer program product. The computer program product includes a program. The computer program product may be applied to a communications apparatus provided in embodiments of this application, and the program causes a computer to perform a method to be performed by the communications apparatus in various embodiments of this application.

An embodiment of this application further provides a computer program. The computer program may be applied to a communications apparatus provided in embodiments of this application, and the computer program causes a computer to perform a method to be performed by the communications apparatus in various embodiments of this application.

It should be understood that, in embodiments of this application, “B corresponding to A” means that B is associated with A, and B may be determined based on A. However, it should also be understood that, determining B based on A does not mean determining B based only on A, but instead B may be determined based on A and/or other information.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one place or distributed on a plurality of network units. Some or all of the units may be selected according to actual needs to achieve the objectives of solutions in embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state disk (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
receiving, by a terminal device, a configuration message, wherein the configuration message is used to determine a delay compensation manner of the terminal device; and
determining, by the terminal device, a target delay compensation manner based on the configuration message.

2. The method according to claim 1, wherein the configuration message is used to instruct the terminal device to perform delay compensation or instruct a network device not to perform delay compensation; and
the determining, by the terminal device, a target delay compensation manner based on the configuration message comprises:
determining, by the terminal device, the target delay compensation manner based on whether the configuration message comprises configuration information of a reference signal.

3. The method according to claim 2, wherein the determining, by the terminal device, the target delay compensation manner based on whether the configuration message comprises configuration information of a reference signal comprises:
determining, by the terminal device, the target delay compensation manner from a timing advance-based (TA-based) delay compensation manner and a round trip time-based (RTT-based) delay compensation manner based on whether the configuration message comprises the configuration information.

4. The method according to claim 3, wherein the determining, by the terminal device, the target delay compensation manner from a TA-based delay compensation manner and a RTT-based delay compensation manner based on whether the configuration message comprises the configuration information comprises:
in a case that the configuration message does not comprise the configuration information, determining, by the terminal device, the TA-based delay compensation manner as the target delay compensation manner.

5. The method according to claim 3, wherein the determining, by the terminal device, the target delay compensation manner from a TA-based delay compensation manner and a RTT-based delay compensation manner based on whether the configuration message comprises the configuration information comprises:
in a case that the configuration message comprises the configuration information, determining, by the terminal device, the RTT-based delay compensation manner as the target delay compensation manner.

6. The method according to claim 3, wherein the determining, by the terminal device, the target delay compensation manner from a TA-based delay compensation manner and a RTT-based delay compensation manner based on whether the configuration message comprises the configuration information comprises:
in a case that the configuration message comprises the configuration information, determining, by the terminal device, the target delay compensation manner from the TA-based delay compensation manner and the RTT-based delay compensation manner based on a reception status of first RTT information.

7. The method according to claim 6, wherein the determining, by the terminal device, the target delay compensation manner from the TA-based delay compensation manner and the RTT-based delay compensation manner based on a reception status of first RTT information comprises:
in a case that the terminal device has not received the first RTT information, determining, by the terminal device, the TA-based delay compensation manner as the target delay compensation manner.

8. The method according to claim 6, wherein the determining, by the terminal device, the target delay compensation manner from the TA-based delay compensation manner and the RTT-based delay compensation manner based on a reception status of first RTT information comprises:
in a case that the terminal device has received the first RTT information, determining, by the terminal device, the RTT-based delay compensation manner as the target delay compensation manner.

9. The method according to claim 2, wherein the reference signal comprises one or more of following signals: a sounding reference signal (SRS), a channel status indication reference signal (CSI RS), a phase tracking reference signal (PTRS), and a tracking reference signal (TRS).

10. A terminal device, comprising at least one processor, and at least one memory including computer program, wherein the at least one memory and the at least one processor are configured with the computer program, to cause the terminal device at least to:
receive, a configuration message, wherein the configuration message is used to determine a delay compensation manner of the terminal device; and
determine, a target delay compensation manner based on the configuration message.

11. The terminal device according to claim 10, wherein the configuration message is used to instruct the terminal device to perform delay compensation or instruct a network device not to perform delay compensation; and
the determine, a target delay compensation manner based on the configuration message comprises:
determining, by the terminal device, the target delay compensation manner based on whether the configuration message comprises configuration information of a reference signal.

12. The terminal device according to claim 11, wherein the determining, by the terminal device, the target delay compensation manner based on whether the configuration message comprises configuration information of a reference signal comprises:
determining, by the terminal device, the target delay compensation manner from a TA-based delay compensation manner and a RTT-based delay compensation manner based on whether the configuration message comprises the configuration information.

13. The terminal device according to claim 12, wherein the determining, by the terminal device, the target delay compensation manner from a TA-based delay compensation manner and a RTT-based delay compensation manner based on whether the configuration message comprises the configuration information comprises:
in a case that the configuration message does not comprise the configuration information, determining, by the terminal device, the TA-based delay compensation manner as the target delay compensation manner.

14. The terminal device according to claim 12, wherein the determining, by the terminal device, the target delay compensation manner from a TA-based delay compensation manner and a RTT-based delay compensation manner based on whether the configuration message comprises the configuration information comprises:
in a case that the configuration message comprises the configuration information, determining, by the terminal device, the RTT-based delay compensation manner as the target delay compensation manner.

15. The terminal device according to claim 12, wherein the determining, by the terminal device, the target delay compensation manner from the TA-based delay compensation manner and the RTT-based delay compensation manner based on a reception status of first RTT information comprises:
in a case that the terminal device has not received the first RTT information, determining, by the terminal device, the TA-based delay compensation manner as the target delay compensation manner.

16. The terminal device according to claim 12, wherein the determining, by the terminal device, the target delay compensation manner from the TA-based delay compensation manner and the RTT-based delay compensation manner based on a reception status of first RTT information comprises:
in a case that the terminal device has received the first RTT information, determining, by the terminal device, the RTT-based delay compensation manner as the target delay compensation manner.

17. The terminal device according to claim 11, wherein the reference signal comprises one or more of following signals: a sounding reference signal (SRS), a channel status indication reference signal (CSI RS), a phase tracking reference signal (PTRS), and a tracking reference signal (TRS).

18. A network device, comprising at least one processor, and at least one memory including computer program, wherein the at least one memory and the at least one processor are configured with the computer program, to cause the network device at least to:
transmit, a configuration message to a terminal device, wherein the configuration message is used to determine a delay compensation manner of the terminal device.

19. The network device according to claim 18, wherein the configuration message is used to instruct the terminal device to perform delay compensation or instruct the network device not to perform delay compensation.

20. The network device according to claim 19, wherein the at least one memory and the at least one processor are configured with the computer program, to further cause the network device at least to:
transmit, first RTT information to the terminal device.
